(19) United States
(12) Patent Application Publication
(10) Pub. No.: US 2022/0198342 A1
(43) Pub. Date: Jun. 23, 2022

(54) METHOD AND DEVICE FOR DETECTING MOORING AND MONITORING OF A NAVIGABLE AREA

(71) Applicant: Jérémy LADOUX, Vic la Gardiole (FR)

(72) Inventor: Jérémy LADOUX, Vic la Gardiole (FR)

(21) Appl. No.: 16/763,996

(22) PCT Filed: Oct. 22, 2018
(86) PCT No.: PCT/FR2018/052627

§ 371 Date: Jun. 1, 2020

(30) Foreign Application Priority Data
Oct. 23, 2017 (FR) 1759958
Dec. 19, 2017 (FR) 1762548

(51) Int. Cl. G06Q 10/02; G06Q 10/04; B63B 51/00; G08G 3/00

(52) U.S. Cl. CPC G06Q 10/02; G08G 3/00; B63B 51/00; G06Q 10/047

(57) ABSTRACT

The device for detecting mooring in a navigable area comprises:
means for detecting the presence of a boat close to a berthing member or attached to said berthing member,
means (56) for transmitting information representative of the detection performed and
means (59) for transmitting a request (58) to a communicating portable terminal (56) associated with the user of the boat of which a movement has been detected, in order to receive, in return, an envisaged duration of presence of the boat in the navigable area.

### TECHNICAL FIELD OF THE INVENTION

The present invention relates to a method and device for detecting mooring and for monitoring a navigable area. It applies to the field of boating, in particular pleasure boating.

### STATE OF THE ART

In yacht harbors, neither the harbormaster's office nor the boat owners have real-time visibility of the berths available. A manual visual survey is generally made on a daily or weekly basis. This practice, which is slow and only daily or weekly, has a number of drawbacks. Firstly, this represents a financial loss for the harbormaster's office due to the non-optimization of places and to the staff needed. Secondly, the port's resident boat owners are not rewarded for declaring their absence and freeing their berth, so that only about 10% of them do this. Lastly, the residents on stopover are faced with an apparent shortage of available places due to manual management. As a result, the stopover request procedure is archaic, ineffective and time-consuming.

The steady rise in the number of boats in operation increases the scale of these problems.

Today, yacht harbors are confronted with a twofold challenge: first, to encourage boat owners to sail their boats, or have them sailed, and, second, to optimize mooring places so as to limit the stationary boats and be able to accommodate visiting boats on the available rings.

However, harbormaster's offices have no precise knowledge of either the places available or the level of departures (or absences). It is therefore very difficult, even impossible, to have real-time management of the movements (entrances/departures) of boats, and thus of the availability of rings, especially in the high season. This results in a significant loss of earnings for the ports. Similarly, the boat owners have no incentive from the harbormaster's office to sail and free their place, and there is often no difference in yearly fees between a stationary boat and an active pleasure boat that makes frequent departures and often frees up its ring.

### SUBJECT OF THE INVENTION

The present invention aims to remedy all or part of these drawbacks.

To this end, according to a first aspect, the present invention envisages a device according to claim 1.

Thanks to these provisions, boat movements in the monitored navigable area are detected automatically and then, by interrogating users of moving boats, a duration of the boat's presence or absence is determined. These responses from the users make it possible to assign places, or rings, to boats entering the navigable area.

In some embodiments, the detection means comprise:
a transmitter-receiver of acoustic waves;
a sensor of light rays;
a transmitter-receiver of infrared rays;
a transmitter-receiver of microwaves;
an electronic tag reader;
an integrated video camera and a shape recognition means configured to detect the presence of a boat, the shape recognition means being configured to recognize a registration number, name or other distinctive sign of the boat, the detection means comprising a comparator comparing the registration number, name or distinctive sign with the registration number, name or distinctive sign of at least one predefined boat;
a movement detector, for example using a dynamometer, MEMS (microelectromechanical systems), or centimetric geolocation;
a mooring ring comprising an air chamber equipped with at least one pressure sensor;
a metal arc set in rotation by a motor; and/or
an accelerometer.

In some embodiments, detection means are mounted on a buoy and/or detection means are mounted on a pontoon.

In some embodiments, transmission means utilize the LoRaWAN protocol or GSM protocol.

Thanks to these provisions, the transmission is performed over a distance of more than one hundred meters and uses a low amount of energy.

According to a second aspect, the present invention relates to a method for monitoring a navigable area, which comprises:
a step of detecting the presence or closeness of a boat by means of a device that is the subject of the invention;
a step of transmitting information representative of detected movements; and
a step of transmitting a request to a communicating portable terminal associated with the user of the boat for which a movement has been detected, in order to receive, in return, an envisaged duration of the boat's presence or absence in the navigable area.

As the particular features, advantages and aims of this method are similar to those of the device that is the subject of the invention, they are not repeated here.

### BRIEF DESCRIPTION OF THE FIGURES

Other advantages, aims and features of the present invention will become apparent from the description that will follow, made, as a non-limiting example, with reference to the drawings included in an appendix, in which:

FIGS. 1 and 2 represent, schematically, screens displayed during absence declaration steps;

FIG. 3 represents, schematically, a screen displayed to change the declared date or time of return;

FIG. 4 represents, schematically, a port in which a particular embodiment of the device that is the subject of the invention is utilized;

FIG. 5 represents, in the form of a logical diagram, steps utilized in a particular embodiment of the method that is the subject of the invention;

FIG. 6 represents, schematically, a first particular embodiment of a boat movement detection means;

FIG. 7 represents, schematically, a second particular embodiment of a boat movement detection means;

FIG. 8 represents, schematically, a port in which a second particular embodiment of the device that is the subject of the invention is utilized;

FIGS. 9 to 13 represent mooring detectors installed on berthing buoys; and

FIG. 14 represents, in the form of a logical diagram, steps utilized in a particular embodiment of the method that is the subject of the invention.

### DESCRIPTION OF EXAMPLES OF REALIZATION OF THE INVENTION

The present description is given in a non-limiting way, each characteristic of an embodiment being able to be combined with any other characteristic of any other embodiment in an advantageous way.

It is now noted that the figures are not to scale.

The invention aims to provide a port solution that helps the harbormasters' offices to identify the entrances and departures in real time in a port so as to communicate more easily with its boat owners, boost tourism and improve the profitability of the port by optimizing the occupation of places.

For the boat owner, it is a simple, fast tool to obtain information before a departure, sail in complete safety, declare his absence while making savings when his place is reused for another boat's stopover.

In other terms, it consists of providing yacht harbors with solutions allowing them to meet their need to identify boat movements so as to optimize the free mooring places, in order to increase their stopover capacity, optimize the places available or better manage the billing of places to owners, based on the movements of the boats in question.

The present invention uses various technical solutions, from the installation of beacons in the boats and passage terminals at the entrance to the port, through to mobile applications that require no installation on board boats. In all cases the system is integrated in a harbormaster office software system, so the harbormaster's office can know in real time which mooring places are available or empty, and the envisaged duration of availability.

In some embodiments of the invention no additional installation is necessary in the port or on the boats. Only a specific software system, or access to a specific software system, has to be installed in the computer system of the harbormaster's office through a web access. This software system is interfaced with the existing management system. Connected to a mobile application for boat owners, the system is based on detecting the geographic position (for example, via a GPS (Global Positioning System, registered trademark) receiver) of a communicating portable terminal (typically a mobile telephone) of the user of each boat when the boat leaves or enters the approach channel to the port, and only in that location. There is therefore no permanent tracking of the boat owner.

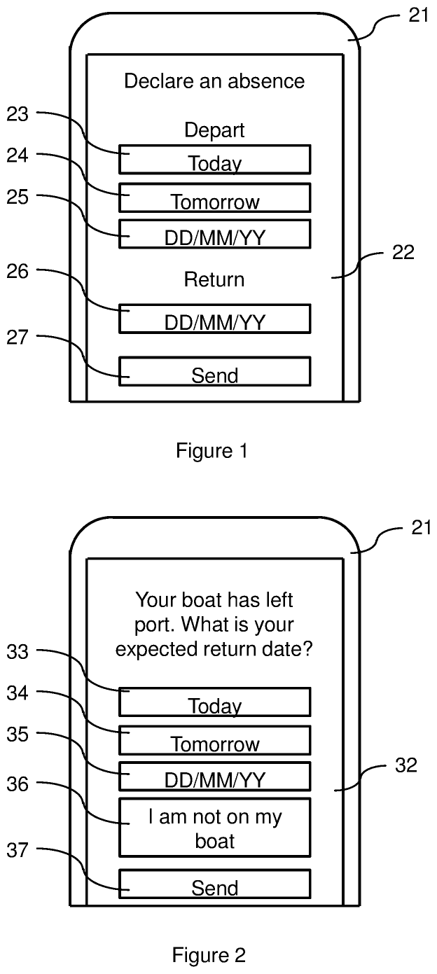

In these embodiments, the user of a boat downloads an application onto his mobile telephone. When he declares an absence, he gives an envisaged return date by means of this application, for example by replying to the question asked on the screen shown in FIG. 1.

FIG. 1 shows a mobile telephone 21 equipped with a screen 22 displaying a heading, “Declare an absence”, and two sub-headings, “Depart” and “Return”. Under the “Depart” sub-heading there are three fields: “Today” 23, “Tomorrow” 24 and a field 25 for entering a date. Under the “Return” sub-heading there is a field 26 for entering a date. Lastly, a “Send” field 27 allows the user to send the entered data.

If this initial declaration is not made, he must operate the geolocation system when his boat moves. The geographic position is compared to a monitored area, for example an area covering the port's channel and, if the position of the boat indicates that it is in the channel, a message is sent, for example in the form of a short message (or SMS, for Short Message System) or a mobile data message sent by the application to a server, which retransmits it to the harbormaster's office.

Preferably, the application detects the direction of travel in the channel, for entering or leaving the port. In the case where the boat is leaving the port, the user is asked when he envisages returning to the port, for example by replying to the question asked on the screen shown in FIG. 2.

FIG. 2 shows a mobile telephone 21 equipped with a screen 32 displaying a question, “Your boat has left the port. What is your expected return date?”, and four fields, including: “Today” 33, “Tomorrow” 34, and a field 35 for entering a date. Field 36, for declaring that the user is not on the boat, cannot be used in these embodiments, but is used when the boat movement is detected by means other than the user's communicating portable terminal. Lastly, a “Send” field 37 allows the user to send the entered data.

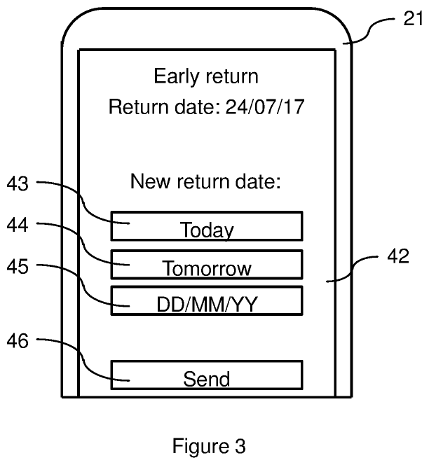

The user can change the envisaged time of his return to port at any time, for example by using the screen shown in FIG. 3.

FIG. 3 shows a mobile telephone 21 equipped with a screen 42 displaying a heading, “Early return”, a reminder of the return date currently declared (in this case, Jul. 24, 2017), and one sub-heading, “return”. Under the “return” sub-heading there are three fields: “Today” 43, “Tomorrow” 44 and a field 45 for entering a date. Lastly, a “Send” field 46 allows the user to send the entered data.

When the application determines that the boat is entering a port that is not the boat's home port, the user is asked, in the same way, about the envisaged duration of presence in the port, so that the harbormaster's office can assign him:
an available ring for this entire length of time;
a series of available rings to cover this entire length of time; or
a maximum authorized duration of presence at a ring or a series of rings, in the case where it is not possible to provide the entering boat with a ring for the entire time.

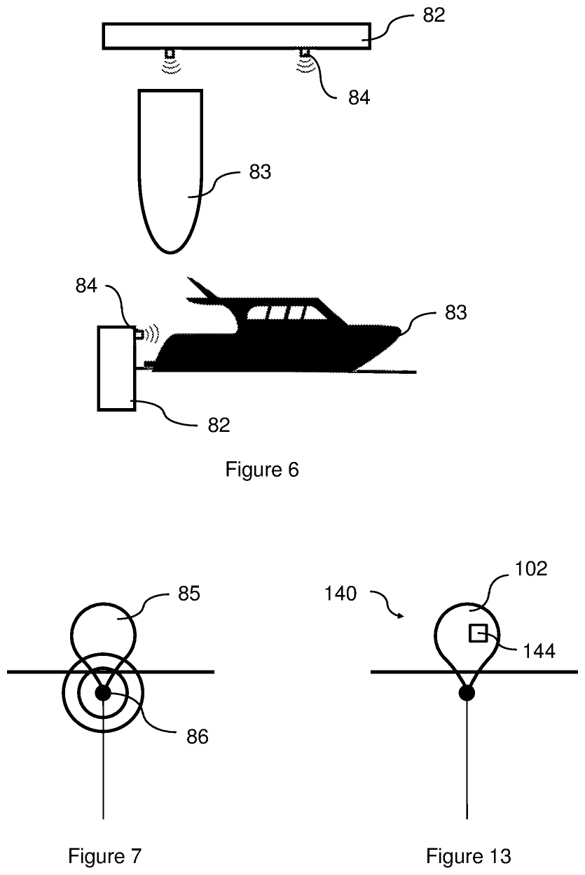

In other embodiments, and possibly in addition to means utilized as described above, equipment can be added to improve the precision of the localization of the boat, which take the form of:
on-board sensors in the boat (see FIG. 6) with or without geolocation;
sensors at the location of the berth (see FIG. 7); and/or
sensors at the location of the berthing buoys (see FIG. 8).

A declaration of absence made by a boat owner is the subject of automatic processing to update the available places and allow departures to be anticipated. For stopovers, the application displays the available stopover places and the resident places, i.e. assigned to a boat, that are temporarily available.

With the harbormaster's software system, the port team can:
view in real time the availability of rings;
receive the automated declarations of absence so as to anticipate departures;
consult the places available for a stopover request; and
access the statistics.

The mobile application to be downloaded onto a portable communicating terminal (mobile telephone, connected watch or tablet, for example) improves the service for boat owners, by providing them with information, weather reports, webcam images and news reports.

Before leaving, the boat owner can consult the weather and view the town's webcams in real time. He can make his declaration of absence beforehand in two clicks, or declare it when he leaves. On stopover, the boat owner is now directed to the tourist office of the destination. He can notify of an early return so that, if the place has been re-let, his harbormaster's office can make arrangements so that he will find his berth free when he arrives.

When the embodiment of the device according to the invention comprises at least one sensor, the mobile application remains preferential because directly interrogating the boat owner during departure makes it possible to anticipate the duration of absence and therefore the availability of the place.

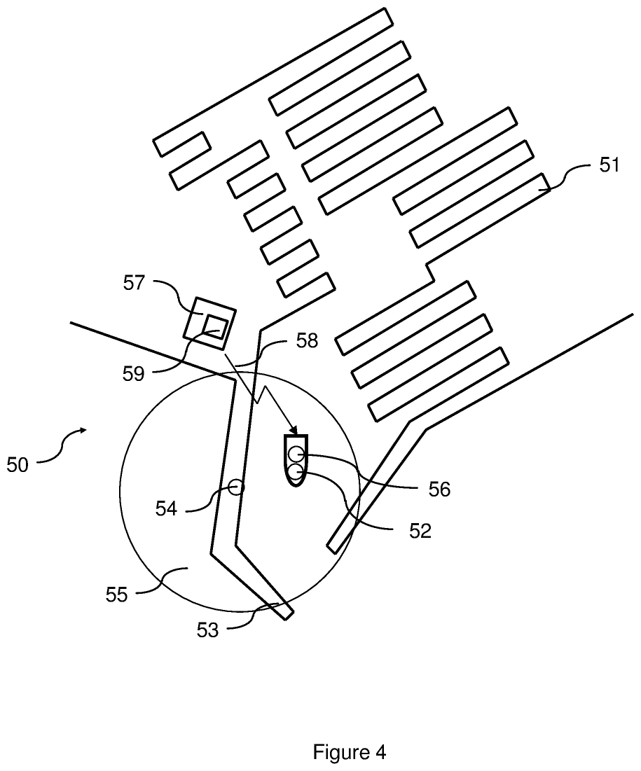

FIG. 4 shows the positioning of a device 50 with regard to a navigable area 51, in this case a port. The device 50 comprises a single terminal for interrogating on-board sensors on the boat. FIG. 4 shows a port 51 having a channel between two jetties 53. A terminal 54 has an interrogation range 55 for interrogating on-board sensors 52 that covers the channel sufficiently so that no boat can leave the port without passing within the range 55.

The on-board sensor 52 on the boat can only capture the signals coming from terminals 54 installed in a port or also comprise a geolocation means, in which case it utilizes the operation described above for an application downloaded onto a communicating portable terminal.

On receiving a request from the terminal 54, the sensor 52 identifies itself. As the identifier of the sensor 52 is associated with a mobile telephone number 56, the harbormaster's software system 57 then, if the user has not declared his departure and his envisaged return date, causes an interrogation request 58 to be sent to the mobile telephone 56 of the user, to obtain this return date, as described with reference to FIG. 2.

In this way, the sensors, terminals or a communicating portable terminal 56 of the user of the boat form means for transmitting information representative of detected movements. The harbormaster's office 57 comprises means 59 for transmitting a request 58 to the communicating portable terminal 56 associated with the user of the boat for which a movement has been detected. This request is intended to receive, in return, an envisaged duration of the boat's presence or absence in the navigable area 51.

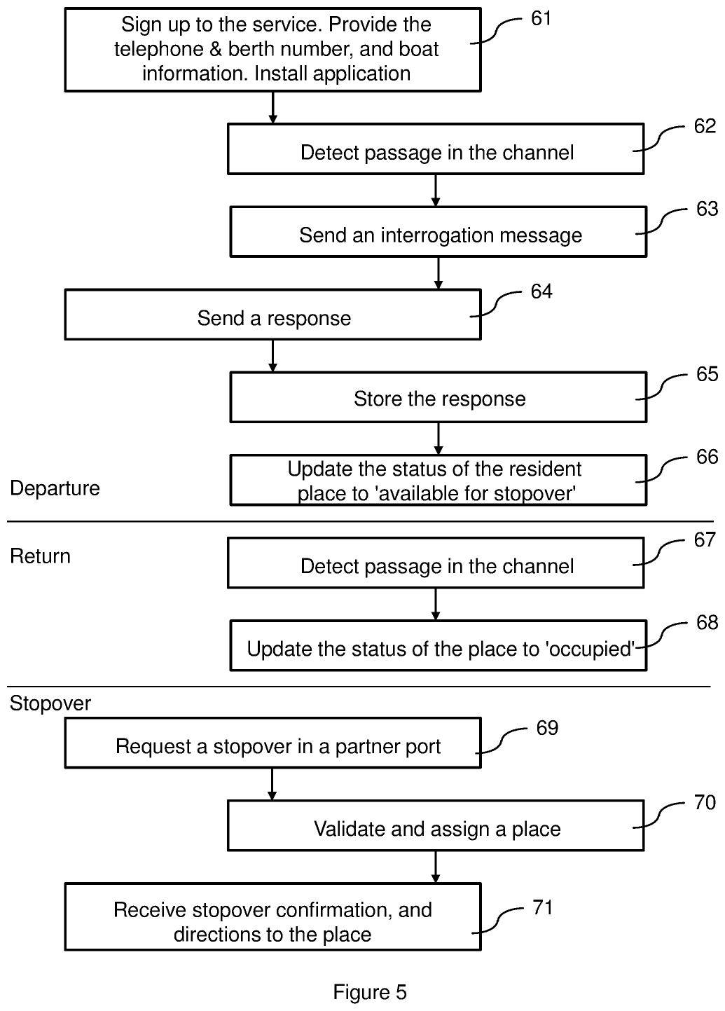

FIG. 5 shows embodiments of the method that is the subject of the invention utilizing the embodiments of the device described above, with no detector at the location of the places or rings. In this FIG. 5, the steps shown on the left are performed at the level of the boat and the steps shown on the right are performed centrally.

These steps comprise, up to the departure of a user:
a step 61 of the user signing up to the service, providing the number of his communicating portable terminal and of his berth in the port, information identifying his boat, and installing the application on this terminal. Possibly, during this step, the user installs a sensor on his boat and an identifier of the sensor is associated with the user's terminal number and with his berth in the port;
a step 62 of detecting the boat's passage in the channel, in the departure direction, either by processing the geographic position or by identifying the on-board sensor and transmitting information representative of detected movements;
a step 63 of sending an interrogation message to the application installed on the user's terminal;
a step 64 of a response by the user's terminal;
a step 65 of storing the user's response;
a step 66 of updating the status of the resident place (the user's berth number) as “available for stopover”, and therefore making the corresponding ring available.
   During the return of this user, the method comprises:
a step 67 of detecting another boat's passage in the channel, as described earlier; and
a step 68 of updating the status of the resident place (the user's berth number) as “occupied”.
   During a stopover, the method comprises:
a step 69 of requesting a stopover in a port utilizing the application, giving information about the boat in order to determine the dimensions of the place required;
a step 70 of assigning a ring to the boat, as a function of the availability of places, and updating the status of this place to “occupied”; and
a step 71 of receiving stopover confirmation, providing the user with indications to guide him to the place (typically a map of the port).

With regard to the embodiments utilizing presence detectors at the resident places of boats, FIGS. 6, 7 and 9 to 13 show two examples of these.

In some embodiments, the detection means at the pontoons, berthing or ring places (especially berthing buoys) comprise:
a transmitter-receiver of acoustic waves;
a sensor of light rays;
a transmitter-receiver of infrared rays;
a transmitter-receiver of microwaves;
an electronic tag reader;
an integrated video camera and a shape recognition means configured to detect the presence of a boat, the shape recognition means being configured to recognize a registration number, name or other distinctive sign of the boat, the detection means comprising a comparator comparing the registration number, name or distinctive sign with the registration number, name or distinctive sign of at least one predefined boat;
a movement detector, for example using a dynamometer, MEMS (microelectromechanical systems), or centimetric geolocation;
a mooring ring comprising an air chamber equipped with at least one pressure sensor;
a metal arc set in rotation by a motor; and/or
an accelerometer.

FIG. 6 shows a pontoon 82 equipped with presence detectors 84 facing boat positions 83.

The detectors 84 include, preferably, several technologies among those using acoustic waves, especially ultrasonic (sonar preferably having a circular output cone having an opening angle of between 10° and 12°); light rays, in particular infrared; microwaves (especially in Doppler detection); light rays; or electronic tags. In some embodiments, the detector 84 comprises an on-board video camera followed by automatic shape recognition to detect the presence of a boat and also the identity of the boat by obtaining its registration number, name or other distinctive signs, and a comparator of shapes and distinctive signs with those of the boat normally resident. The lens of the video camera can be coated to overcome privacy problems in some markets. In some embodiments, a radio transmitter is on board the boat, and a pontoon sensor is facing the berth. This solution makes it possible to detect if a boat is present or not at the berth, and to capture the identity of the boat when it is moored at a place equipped with a pontoon sensor. The on-board radio transmitter sends a unique signal specific to each boat, enabling the resident boat or a boat from another port equipped with the same system to be accurately identified.

FIG. 7 shows a berthing buoy 85 equipped with a detector 86. Preferably, the detectors 86 include several technologies among those indicated above, and also movement detectors, for example using a dynamometer, MEMS (microelectromechanical systems), or centimetric geolocation.

In the two types of detector, the information is preferably uploaded using radio waves in the Hertzian frequency, or via the mobile telephone network.

With regard to the harbormaster's office, the advantages of the utilization of the invention include, in operational terms, real-time visibility of the berths available, better management of berths and occupancies, automation of the absence declarations, anticipation of periods of absence, improved communication with the boat owners, and safety.

And, in financial terms, revenue is increased by increasing the number of stopovers, and optimizing the rate schedule (“Yield Management”).

In terms of human resources management, staff are assigned to tasks with a high added value, and fewer seasonal workers are required.

With regard to the boat owners, the advantages of the utilization of the invention include, in operational terms, improved services, information before a departure, information about the destination, simplified absence declaration, safety, receiving alerts (thefts, dangerous areas), and responsible boating.

And, in financial terms, savings by freeing his place.

The advantage of anticipating periods of absence means that a larger number of mooring places can be proposed, at any time, whether on an ad-hoc basis for boats making short trips or for longer durations for the places of boats departing for a longer time.

For example, if one resident boat is absent from February to July and a second resident boat from June to October, then the port has one additional place 9 months out of 12, and the rest of the time the visiting boat can be taken out of the water.

The port's total capacity can thus be increased, without any financially costly and uncertain expansion of the port's capacity.

With regard to detecting a boat's departure from the port, in some embodiments LoRa (Long Range) technology is utilized. Its main advantages are long range, low power, low data flow of the networks, wireless, geolocation without GPS, bi-directional and LoRaWAN standard.

LoRa is a radio protocol using the 868 MHz band. LoRaWAN is a standard, and LoRaWAN objects are compatible with each other and with the towns equipped with LoRa (Bordeaux, Marseille, Nice, Montpellier, Paris). A single antenna handles all connected object requirements. The LoRa protocol is bi-directional, i.e. the objects can be activated on demand, which means they can be less energy intensive. Geolocation without GPS is very precise with LoRa.

With regard to the on-board LoRa sensor, it is compatible with the IP66 standard for a maritime environment and is UV-protected. It has an autonomy of three years. An autonomous tracker enables localization and identification of passage. It has coverage of up to 200 meters.

A gateway antenna (“Gateway”) allows information to be uploaded via a multi-operator 3G mobile telephone network to the harbormaster's software system. This antenna is autonomous thanks to the solar panel. The data transmitted is made secure via a VPN-APN tunnel.

FIG. 8 shows, in a device 90 according to the invention, LoRa trackers deployed so that, combined, their ranges 92 to 96 cover all of a mooring area for the port 51. Four inner trackers transmit signals for zoning localization. A departure tracker transmits signals for passage detection in the channel. In addition two berthing buoys 97 and 98 are equipped with boat presence detectors.

Each sensor records the tracker no. and the time. It sends the information to the antenna. The inner trackers operate on a regular basis and the departure tracker on a spontaneous basis.

With regard to the schematic for the uploading of information:
a tracker (Zoner) transmits signals (beacons) in a maximum radius of 200 meters;
a boat equipped with a sensor (Tag) enters the area of the tracker, receives the signal, sends information containing its tracker no., the tracker no. of the entrance area and of the last departure area, RTC (Date-Time), and Temperature to the antenna (Gateway);
via a secure APN-VPN channel of its 3G modem, the antenna (Gateway) uploads information to the tracker, sensor and gateway deployment service provider's servers;
the information is automatically sent to the servers of the solution's operator via a Web service (API) between the two platforms, which enables a tracker to be authenticated to a boat owner and, by means of the harbormaster's software system, his presence or not in the port to be displayed.

Precision Through the Association of Sensor/Mobile Telephone:

A boat owner equipped with the mobile application who leaves the port with his boat, which is equipped with a sensor, therefore receives a (push) message as he departs in order to find out his return date. A boat owner who is on another boat owner's boat does not receive this push message because there was no association of Application and sensor for validating the departure of the right boat.

With regard to an event concerning crossing through areas (active detection), when a boat changes area (entry or departure), detection of the change of area is automatically uploaded as an alarm.

With regard to an event concerning presence validation (passive detection), the sensors are configured to confirm their presence in the last known area regularly.

With regard to the embodiments with an on-board GPS chip solution, one schematic for the uploading of information is as follows:
a boat equipped with a GPS tracker regularly sends its GPS position directly via servers;
the information is automatically sent to the servers of the solution's operator via a Web service (API) between the two platforms, which enables a GPS tracker no. to be authenticated to a boat owner and, by means of the harbormaster's software system, the boat's presence or not in the port to be processed and displayed; and
regularly, at midnight every Sunday, a copy of the week's log is sent by email to the harbormaster's office.

With regard to the embodiments with boat presence detectors at the location of a pontoon (FIG. 6) or a smart ring (FIG. 7), the schematic for the uploading of information can be the following:
a sensor is placed on the quay or pontoon in front of each berth, and periodically tests for the presence or not of a boat;
the information is sent to the antenna (gateway), which automatically sends it to the servers of the solution's operator, which makes it possible to display the presence or absence of a boat at this berth through the moorage map of the harbormaster's software system; and
regularly, at midnight every Sunday, a copy of the week's log is sent by email to the harbormaster's office.

The presence sensor can use different detection technologies, such as ultrasound, optical, microwaves, and upload the information via a public or private network of Hertzian radio waves using various protocols, such as LoRa, ZWave, Zigbee or Sigfox technology (registered trademarks). In this way, a smart ring can be created in the form of a tension sensor on the ring or mooring cleat/bollard. This information is sent to the antenna (gateway), which automatically sends it to the servers of the solution's operator, which makes it possible to display the availability or absence of a boat at this berth through the moorage map of the harbormaster's office software. Regularly, at midnight every Sunday, a copy of the week's log is sent by email to the harbormaster's office.

With Regard to the Boat Owner Application:

### A/Leaving the Port (FIG. 6)

1^{st} detection in the departure area, reported to the software;
2^{nd} detection in the departure area, reported to the software;
the two geographic positions of the detections are calculated, indicating the direction of the boat's movement, on leaving the port.

At the level of the harbormaster's office, this detection triggers:
the displaying of the moorage map with an orange-colored slot for the berth. This color indicates a sea trip with no return date;
a countdown.

A predefined length of time, for example ten minutes, after leaving the port, a message is sent to the application of the boat owner associated, in the memory, with the sensor that has been identified as leaving the port. This message notifies the owner of the boat's departure and asks him for the return date.

Based on the reply, the harbormaster's software system automatically frees the space for stopover for the declared number of nights away. In addition, a credit for the number of nights away is declared in the boat owner's profile.

Boat owner's side: selection of the period of absence to be changed, and changing the return date of the declared period of absence. Harbormaster's office side: automatic display of the berth's new period of availability for stopover, and automatic updating of the declared number of days away in the boat owner's record.

### B/Entering a Stopover Port:

1^{st} detection in the departure area, reported to the software;
2^{nd} detection in the departure area, reported to the software;
the two geographic positions of the detections are calculated, enabling entry into a stopover port to be determined;
push message (i.e. information “pushed” without a request from the user's terminal) sent with information about the port and the destination+“possibility of booking services”;
if the boat owner has booked a stopover place and the harbor master's office has entered it into the software system, then:
   i) A map of the moorage area with the place reserved is sent;
   ii) After 5 to 10 minutes, a push message is sent with information about the port and the destination, offering the possibility of booking services.

### C/Leaving the Stopover Port:

1^{st} detection in the departure area, reported to the software;
2^{nd} detection in the departure area, reported to the software;
the two geographic positions of the detections are calculated to determine the direction of departure from the stopover port;
if this is the last day of the stopover, a push message is sent for an overall rating of the stopover; and
after the boat owner replies, the opinion is received in the harbormaster's office software.

### D/Detecting a Boat Off the Port:

Definition of an area off the port, for picking up new visiting boat owners;
1^{st} detection in the off-shore area, reported to the software;
2^{nd} detection in the off-shore area, reported to the software;
the two geographic positions of the detections are calculated, indicating the direction of the off-shore passage to the right of the yacht harbor;
a push message is sent with information about the port and the destination, and the possibility of booking a stopover place.

### E/Returning to the Home Port:

1^{st} detection in the departure area, reported to the software;
2^{nd} detection in the departure area, reported to the software;
the two geographic positions of the detections are calculated, showing an entry, i.e. a return to the home port;
the moorage map is displayed with a boat icon at the berth indicating the boat's presence in the port;
a push message is sent with a “Welcome home!” return message.

In addition, the boat owners' mobile application proposes the reception of alerts about the draft in the areas of sandbanks or port entrances, or when the user enters a restricted anchorage area or an area with no holding tank.

For the embodiments comprising on-board LoRa sensors, these can involve radio-frequency tags or IP 66 tags for marine environments. The tags are placed on the boats to be monitored. The more visible the tag (prominently placed), the more flexible the coverage is for all cases and all ports. Programming the frequency of data collection is performed using an IoT platform. The tags contain a lithium battery that can potentially be replaced (but requires the product to be removed and completely opened). The battery level is shown as a percentage in all the periodic frames; an alarm is transmitted at the end of its life.

They send to the gateway(s) on a regular basis, but can also send on a spontaneous basis in the form of an event-based alarm, such as the passage covered by a tracker configured for this.

The autonomous trackers enable localization and/or identification of passage. Autonomous trackers regularly sending Beacons. The range of coverage can be adjusted from two meters to approximately 200 meters. At least one tracker is installed at the exit from the channel (departure from the port) and one upstream on the inside, to determine the direction of passage.

The gateway is installed at the level of the harbormaster's office, or on a pontoon. It comprises a sealed housing, a battery and a solar panel charger, and is configured for installation without intrusion. The gateways are remote access points that can be used to reach the devices and the infrastructure in real time (reconfiguration, verification, inventory, etc).

With regard to the localization and the uploading of information on a regular basis:

a. the tags are placed on the boats;
b. at least one tracker is installed at the exit from the channel (departure from the port) and one upstream on the inside, to determine the direction of passage; The installation can be multiplied based on the width of the channel, and also on the radio constraints arising from the inclusion of tags on the boats. Other trackers may be installed in the port itself to offer macro-localization.

At every passage in the area of a tracker, the tag records the identifier of the tag and timestamps this event. Regularly (typically every four hours), the tag sends the latest presence frame(s) of the inner areas of the port covered by “trackers”. There can be multiple (and possibly roaming) gateways if the port is divided into several separate areas, for example, otherwise there is one gateway per port. If the boat is far out to sea during this transmission phase, the tag is not acknowledged and keeps these unsent elements for the next transmission.

For the periodic and alarm-based spontaneous uploading:

c. Same infrastructure as above, but the channel exit trackers are configured so that the tags detecting them send a spontaneous alarm to the gateway. As above, the positioning of another tracker upstream from the exit flows will also be indicated in this alarm, to distinguish between boats entering and leaving.
d. In this case, periodic sending continues and potentially enables confirmation of the data received spontaneously.

The platform managing the connectivity and objects operates in SaaS (Software as a Service) mode.

a. Scalable, modular data management platforms, decompartmentalization of flows between the objects and services.
b. Graphs, diagrams, maps, etc—you have dynamic dashboards for monitoring the activity of the passage terminals and counters, and view the uploaded data, threshold alerts received.
c. Creation of specific widgets according to the data you want to see and in what form.
d. Storage of data and access to the IoT platform in SaaS:
Interfacing tracking data for boats entering and leaving and passage flows with the management platform;
Storage of all data with no time-limit;
Secure access to the data.
For the schematic for the uploading of information:
   1. A tracker (Zoner) transmits signals (beacons) in a maximum radius of 200 meters.
   2. A boat equipped with a sensor (Tag) enters the area of the tracker, receives the signal, sends information containing its tracker no., the tracker no. of the entrance area and of the last departure area, RTC (Date-Time), and Temperature to the antenna (Gateway).
   3. Via a secure APN-VPN channel of its 3G modem, the antenna (Gateway) uploads information to the tracker, sensor and gateway deployment service provider's servers.
   4. The information is automatically sent to the servers of the solution's operator via a webservice (API) between the two platforms, which enables a tracker to be authenticated to a boat owner and, by means of the harbormaster's software system, the boat's presence or not in the port to be displayed.
   5. Regularly, at midnight every Sunday, a copy of the week's log is sent by email to the harbormaster's office.
   6. Precision through the association of sensor/mobile telephone:

A boat owner equipped with the mobile application who is leaving the port with his boat, which is equipped with a sensor, would therefore receive a (push) message as he departs in order to find out his return date; and

A boat owner who is on another boat owner's boat would not receive this push because there was no association of application and sensor for validating the departure of the right boat.

With regard to configuration, only the port entry/departure zoner(s) will be configured as “active” (alarm mode on change of area), the other zoners will be “passive” (they are only seen in the presence frames if there is a change of area).

Thanks to detection by tracked area(s), and possibly on-board sensors on board boats, the present invention effectively resolves the problem of detecting free places and boats entering and leaving the port.

Detection in a Tracked Area of a Port is Carried Out by:
passage detection in the channel (geolocalized coordinates);
absence detection for a set of LoRa cells covering the entire port monitored;
absence detection for a set of RFID cells covering each berth of the port monitored.

Then, there is an uploading of centralized data.

In some embodiments, the boat's passage is detected by detecting the boat's absence for a set of RFID, LORA or GSM cells.

The information is uploaded and then the boat owner is interrogated by means of the on-board software system (mobile application) when a departure is recorded by a sensor or the application through geolocation in the departure area, so as to know the boat owner's return date.

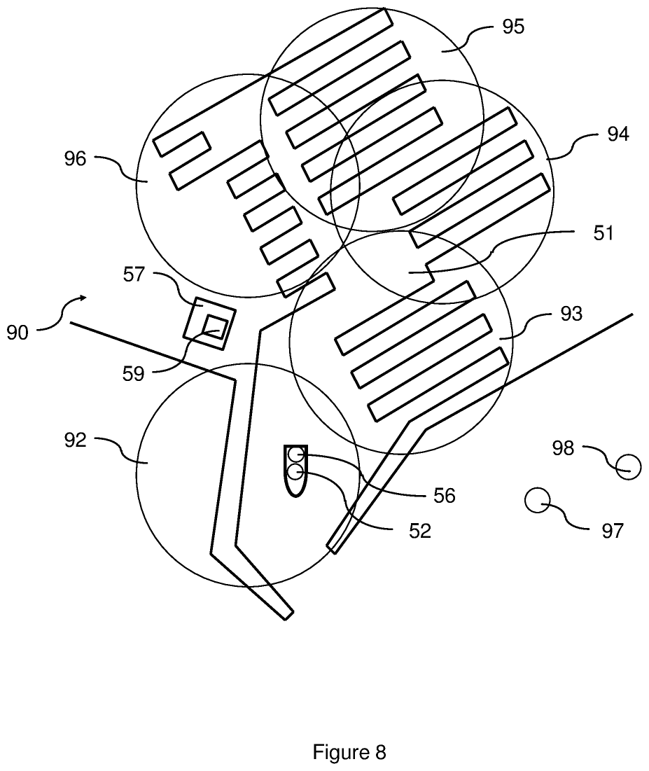

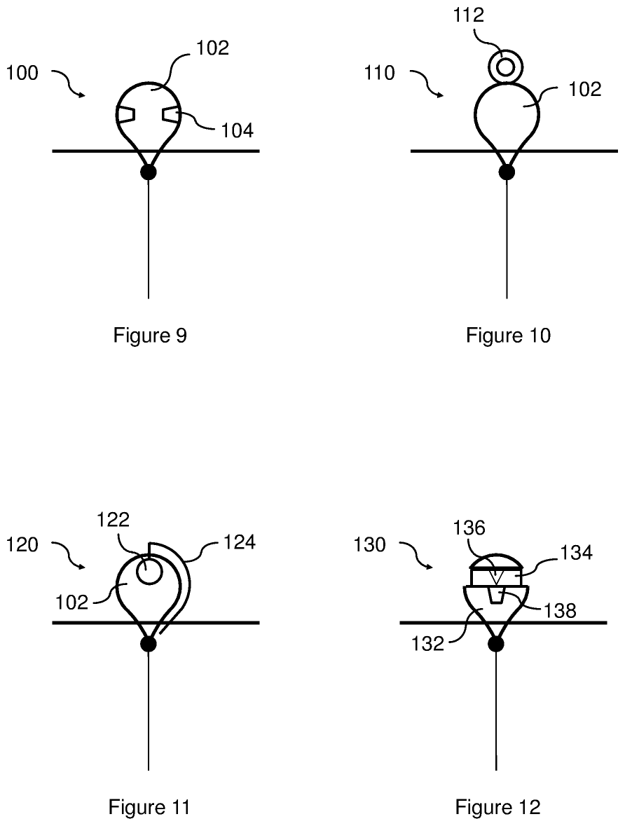

FIGS. 9 to 13 represent mooring detectors installed on berthing buoys. However, these mooring berths can also, according to the present invention, be installed on berthing rings or other fixed points to which boats can be moored.

With what is shown in FIG. 7, these figures describe a sensor or detector of the presence of a boat moored to a berthing buoy. The resulting detection, performed in real time, enables the management of mooring areas, as described above.

In FIG. 9, the system 100 detecting boat mooring comprises, in a buoy 102, radar or sonar detectors 104 as described above with regard to the detection at the location of a pontoon. Preferably, the detectors 104 are multi-directional ultrasonic radars with conical outlets so as to improve the directivity and detect the near presence of a boat over approximately 360°. The detection information is uploaded by hertzian waves on LoRa (registered trademark) channel 868 MHz, then transmitted to the servers by Ethernet, a server that updates the occupation status of the buoy on the interactive moorage map of the harbormaster's office software.

In a variant, the detectors 104 comprise a video camera or optical sensor, for example transmitting and receiving infra-red waves.

In the embodiment 110 shown in FIG. 10, a mooring ring 112 located at the top of buoy 102 comprises an air chamber equipped with at least one on-board pressure sensor. When a line is knotted on the ring this creates pressure in the ring that is detected, and information on the detection of a boat mooring on the buoy is uploaded as described above.

In the embodiment 120 shown in FIG. 11, a metal arc 124 that follows the vertical profile of the buoy 102 is set in rotation relative to the axis of the buoy 102 by a motor 122. The motor 122 regularly makes the arc 124 turn around the buoy 102. If a boat is moored on the arc 124, the latter is held in its rotation, and the presence of a boat is detected by measuring the electrical consumption of the motor 122. If a boat moors under the buoy 102, the arc 104 is also held or slowed during its movement, which enables the boat to be detected.

In the embodiment 130 shown in FIG. 12, mooring on the buoy 132 is detected by reflecting acoustic or optical signals via a prism or mirror 136 set in rotation by a motor 138.

The principle is to use a single sensor for the buoy and a prism or mirror reflecting the wave in several directions successively. Reflection makes it possible to scan a wide field around the buoy 132.

In the embodiment 140 shown in FIG. 13, an accelerometer 144, for example a microelectromechanical system (“MEMS”), is incorporated into a buoy 102. By processing the verticality of the buoy 102, one detects that the average arrangement of the buoy is not vertical for a duration that is several seconds longer than the average duration between two waves, which is representative of the mooring of a boat. After defining a filtering of frequencies corresponding to wave movements, one detects whether the buoy is free or is inclined due to the mooring of a boat.

All the detection technologies work for the uploading of information, for example by radio transmission using LoRa channel 868 MHz.

In a variant, the sensor battery is powered by the oscillation of a magnetic pendulum, which creates friction energy by passing in front of a magnet equipped with an electromagnetic coil.

Generally, all the detection means described in the description regarding the pontoons and all the detection means described in the description regarding the buoys are interchangeable and make it possible to detect the presence of a boat close to a berthing member or attached to said berthing member.

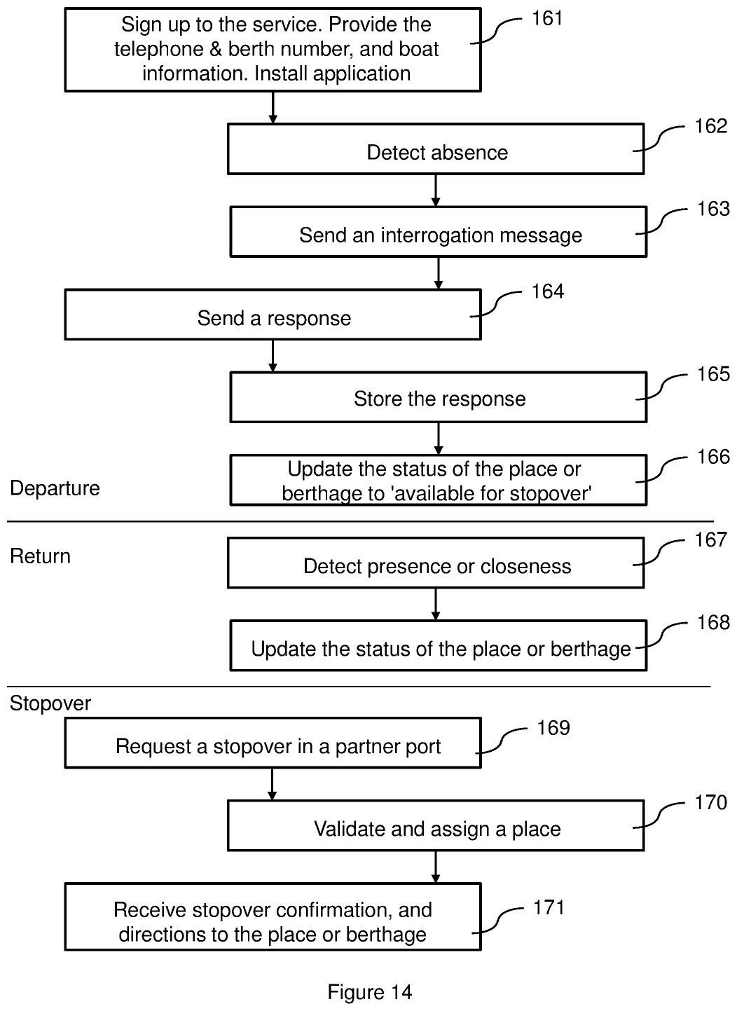

FIG. 14 shows embodiments of the method that is the subject of the invention utilizing the embodiments of the device that is the subject of the invention described above, with detectors at the location of the pontoons, places or rings and/or detectors at the location of berthages, in particular berthing buoys. In this FIG. 14, the steps shown on the left are performed at the level of the boat and the steps shown on the right are performed centrally.

These steps comprise, up to the departure of a user:
a step 161 similar to step 61;
a step 162 of detecting the absence of a boat;
a step 163 of sending an interrogation message to the application installed on the user's terminal;
a step 164 of a response by the user's terminal;
a step 165 of storing the user's response;
a step 166 of updating the status of the resident place (the user's berth number) or berthage as “available for stopover”, and therefore making the corresponding ring or berth available.
   During the return of this user, the method comprises:
a step 167 of detecting the presence or closeness of the boat;
a step 168 of updating the status of the resident place (the user's berth number) or berthage as “occupied”.
   During a stopover, the method comprises:
a step 169 of requesting a stopover in a port utilizing the application, giving information about the boat in order to determine the dimensions of the place required;
a step 170 of assigning a ring or berthage to the boat, as a function of the availability of places, and updating the status of these places to “occupied”; and
a step 171 of receiving stopover confirmation, providing the user with indications to guide him to the place or berthage (typically a map of the port).

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A device for detecting mooring in a navigable area, that comprises:
at least one detector of a presence of a boat close to a berthing member in the navigable area or attached to said berthing member,
an information transmitter of information representative of said detected presence,
a database for associating a boat to a change of detected presence and for associating a communicating mobile terminal of a user with the boat for which a detected presence has changed, and
a request transmitter to the communicating mobile terminal associated with the user of a boat for which a detected presence has changed, requesting to receive, in return, an envisaged duration of the boat's presence in the navigable area.

19. The device according to claim 18, wherein at least one detector comprises a detector of a force or mechanical resistance exerted by a boat on a berthing member.

20. The device according to claim 18, wherein at least one detector comprises a transmitter-receiver of acoustic waves.

21. The device according to claim 18, wherein at least one detector comprises a sensor of light rays.

22. The device according to claim 18, wherein at least one detector comprises a transmitter-receiver of infrared rays.

23. The device according to claim 18, wherein at least one detector comprises a transmitter-receiver of microwaves.

24. The device according to claim 18, wherein at least one detector comprises an electronic tag reader.

25. The device according to claim 18, wherein at least one detector comprises an integrated video camera and a shape recognizer configured to detect the presence of a boat.

26. The device according to claim 25, wherein the shape recognizer is configured to recognize a registration number, name or other distinctive sign of the boat, and the detector comprises a comparator comparing the recognized registration number, name or distinctive sign with the registration number, name or distinctive sign of at least one predefined boat.

27. The device according to claim 18, wherein at least one detector comprises a movement detector.

28. The device according to claim 27, wherein at least one movement detector comprises a dynamometer.

29. The device according to claim 27, wherein at least one movement detector comprises a microelectromechanical system.

30. The device according to claim 27, wherein at least one movement detector comprises a centimetric geolocation system.

31. The device according to claim 18, wherein at least one movement detector comprises a mooring ring comprising an air chamber equipped with at least one pressure sensor.

32. The device according to claim 18, wherein at least one movement detector comprises a metal arc set in rotation by a motor.

33. The device according to claim 18, wherein at least one movement detector comprises an accelerometer.

34. The device according to claim 18, wherein at least one movement detector is mounted on a buoy.

35. The device according to claim 18, wherein at least one movement detector is mounted on a pontoon.

36. The device according to claim 18, wherein at least one transmitter is configured to use a LoRaWAN protocol or a GSM protocol.

37. A method for detecting mooring in a navigable area, that comprises:
detecting a presence of a boat close to a berthing member in the navigable area or attached to said berthing member,
transmitting an information representative of said detected presence,
associating a boat to a change of detected presence,
associating a communicating mobile terminal of a user with the boat for which a detected presence has changed; and
transmitting a request to the communicating mobile terminal requesting to receive, in return, an envisaged duration of the boat's presence in the navigable area.
